(19) United States
(12) Patent Application Publication
(10) Pub. No.: US 2014/0053879 A1
(43) Pub. Date: Feb. 27, 2014

(54) Method Of Cleaning

(71) Applicants: Marine Cabirol, Ludwigshafen (DE); Claudia Schmaelzle, Ludwigshafen (DE); Lucia Krubasik, Ludwigshafen (DE); Jörg Pflug, Ludwigshafen (DE)

(72) Inventors: Marine Cabirol, Ludwigshafen (DE); Claudia Schmaelzle, Ludwigshafen (DE); Lucia Krubasik, Ludwigshafen (DE); Jörg Pflug, Ludwigshafen (DE)

(73) Assignee: RECKITT BENCKISER N.V., Hoofddorp (NL)

(21) Appl. No.: 13/990,420

(22) PCT Filed: Nov. 28, 2011
(86) PCT No.: PCT/GB2011/052342

§ 371 Date: Jul. 9, 2013

(30) Foreign Application Priority Data
Nov. 30, 2010 (GB) 1020252.1

(51) Int. Cl. C11D 11/00; A47L 15/00

(52) U.S. Cl. CPC C11D 11/0058; A47L 15/0007
USPC 134/25.2; 134/34

(57) ABSTRACT

The invention comprises a method of cleaning a kitchenware article, the method comprising a pre-treatment step in which a pre-cleaning composition is applied to the kitchenware article; and a dishwashing step in which the kitchenware article is washed in a dishwashing machine using a dishwashing composition; characterised in that the pre-cleaning composition is ejected from a pressurised aerosol canister and provides a cleaning foam on the surface of the kitchenware article.

This invention relates to a method of cleaning, in particular to a method of cleaning a kitchenware article, in a machine dishwasher.

Machine dishwashing is convenient and labour saving but may not be successful in removing some food soils in a single dishwashing cycle. Baked-on cooking residues can be particularly adherent.

Pre-treatment compositions for application to soiled kitchenware prior to machine dishwashing are known. WO 03/027218 describes a hard-surface cleaning composition which may remove baked-on food soil from cookware and tableware. The composition comprises a smectite-type clay thickening agent and a hydrophobically modified polyacrylate polymer. The composition can be used as a pre-treatment prior to the dishwashing process. Also trigger spray products for treating food soils have been available commercially, see for example the Dawn™ Power Dissolver product.

Foam or foam-forming compositions are known for general cleaning uses and for oven cleaning. U.S. Pat. No. 5,902,225 describes a gel composition which foams when dispensed from a pressurised container (“initial-stage foaming”), then undergoes a second stage of further foaming (“post-foaming”), for personal care and household and industrial cleaning products. GB 1,126,212 describes oven cleaning aerosol compositions. Aerosol dispensers for foam household chemical products are known from e.g. WO 2005/037970, WO 2007/111962 and DE 10 2009 001 493. Also dishwashing kits comprising a container with a foam generating dispenser and a dishwashing composition within the container are known from WO 2004/078903. Pre-treatment of food soils prior to washing is disclosed in EP-A-268, 064.

It is an object of the present invention to provide an improved, or useful alternative, dishwashing method, in particular to tackle the problem of removing baked-on kitchen soils and especially in a convenient to use pack.

According to a first aspect of the present invention there is provided a method of cleaning a kitchenware article, the method comprising:
a pre-treatment step in which a pre-cleaning composition is applied to the kitchenware article; and
a dishwashing step in which the kitchenware article is washed in a dishwashing machine using a dishwashing composition;

characterised in that the pre-cleaning composition is ejected from a pressurised aerosol canister and provides a cleaning foam on the surface of the kitchenware article.

In the pre-treatment step the pre-cleaning composition may be applied to substantially the entire cooking surface of the kitchenware article. By cooking surface we mean the surface of the kitchenware article which is liable to come into contact with food.

Alternatively, in the pre-treatment step the pre-cleaning composition is applied to a part only of the cooking surface of the kitchenware article; preferably locally onto a part of the cooking surface which is heavily soiled by food.

A pressurised aerosol canister is an apt delivery means for the pre-cleaning composition because it allows for accurate delivery of that pre-cleaning composition. This is a particularly useful characteristic when the method of the present invention is used to target food soils. Using the pressurised aerosol canister this may be done accurately and without wastage of the pre-cleaning composition; unsoiled parts of the cooking surface are preferably left substantially uncoated.

Food soils to which the pre-cleaning composition may be applied include proteinaceous and greasy soils.

Food soils may typically be found on kitchenware used for baking, casseroling and cooking on a hob. The kitchenware may, for example include ceramic articles, vitreous articles, metal dishes, baking trays, roasting pans, saucepans etc., table chinaware, glasses and cutlery.

The pre-cleaning composition, when it is inside the pressurised aerosol canister, is suitably a liquid or a gel. Suitably it contains a propellant. When permitted to leave the canister it forms a foam, either immediately or after an interval.

The pre-cleaning composition may be applied to the surface of the kitchenware article as a foam. This may occur when the pre-cleaning composition forms a foam immediately on exiting the canister or after exiting the canister, but before it reaches the kitchenware article.

In an alternative embodiment the pre-cleaning composition is still in the form of a liquid or gel when it is applied to the kitchenware article, and it subsequently foams.

In a further alternative embodiment the pre-cleaning composition is already a foam when it reaches the kitchenware article, but subsequently undergoes a second stage of foaming, when on the surface of the kitchenware article.

Foaming when the pre-cleaning composition exits the canister or soon after it exits the canister, before it reaches the kitchenware article, may be caused by the pressure release on exiting. Foaming which continues on the kitchenware article may be caused by the escape of propellant from the pre-cleaning composition. Nevertheless the physical attributes of the foam may be same, however formed.

Embodiments in which foaming (including further foaming) take place on the kitchenware article are believed to be particularly advantageous because the dynamic process of foam formation in situ is believed to promote intimate contact between the chemical cleaning agents carried by the foam, and food soils on the kitchenware article.

The foam may have the quality that it forms, and then dies away relatively quickly, for example within ten minutes of forming. Alternatively it may be a longer-lasting foam, and may even be a foam which is sufficiently persistent to remain as a foam for an extended period, before the kitchenware article is washed in the machine dishwasher, in the washing step of the present invention. For example the foam may persist for at least two hours, preferably for at least four hours, and in some embodiments, for at least eight hours.

In some embodiments the foam may be a coarse foam or a weak foam. In some embodiments the foam may be a fine foam or a strong foam, for example a crème or mousse.

The foam is preferably able to cling to a vertical or inclined surface.

The foam may be self-standing.

Preferably a pre-cleaning composition which foams, or foams further, on the kitchenware article has finished its foaming within 20 minutes of being applied to the kitchenware article, preferably within 10 minutes, preferably within 5 minutes, preferably within 2 minutes, and most preferably within 1 minute.

Preferably the expansion coefficient for a foam—whether a foam which is applied as a foam to the kitchenware article and/or a foam which forms on a kitchenware article—is up to 1000%, preferably up to 500%, preferably up to 100%, preferably up to 50%, and most preferably up to 30%. Preferably the expansion coefficient is at least 5%, preferably at least 10%. By expansion coefficient we refer to the ratio of the volume of the fully expanded foam, on the kitchenware article, to the pre-cleaning composition when unfoamed.

The foam may be a light foam which may be regarded as a perturbation of the pre-cleaning composition by escaping “bubbles” of the propellant.

Preferably the pre-treatment step includes a dwell time, after the pre-cleaning composition is applied to the kitchenware article, and lasting until the commencement of the washing step. Preferably the dwell time is at least 5 minutes, preferably at least 15 minutes, more preferably at least 30 minutes, more preferably at least 1 hour, more preferably at least 8 hours, and more preferably at least 12 hours. Preferably the dwell time is up to 30 hours, preferably up to 24 hours.

The pre-cleaning composition preferably has a pH in the range 7-13, preferably 7-10.

Suitable components of a pre-cleaning composition are as follows:

Builders

The pre-cleaning composition may also comprise conventional amounts of detergent builders which may be either phosphorous based (e.g. STPP) or non-phosphorous based, or even a combination of both types. Suitable builders are well known in the art. Non-phosphorous builders are preferred.

Non-phosphorous based builder may be organic molecules with carboxylic group(s), amino acid based compound or a succinic acid or succinate based compound.

Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred.

Preferably the total amount of builder present in the compositions of the invention is an amount of at least 5% wt, preferably at least 10% wt, more preferably at least 20% wt, and most preferably at least 25% wt.

Preferably the total amount of builder present in the compositions of the invention is an amount of up to 70% wt, preferably up to 60% wt, more preferably up to 50% wt, and most preferably up to 40% wt.

Surfactants

The detergent compositions of the invention may contain surfactants. Preferred surfactants are anionic surfactants and non-ionic surfactants. Many such surfactants are described in Kirk Othmer's Encyclopedia of Chemical Technology, 3rd Ed., Vol. 22, pp. 360-379, “Surfactants and Detersive Systems”.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

Preferably the surfactant(s) is/are present in the composition of the invention in an amount of from 0.1% wt, more preferably from 0.2% wt, most preferably from 0.5% wt.

Preferably the surfactant(s) is/are present in the composition of the invention in an amount of up to 10% wt, preferably up to 5% wt, most preferably up to 3% wt.

Anti-Corrosion Agents

It is known to include a source of multivalent ions in cleaning compositions, and in particular in automatic dishwashing compositions, for technical and/or performance reasons. For example, multivalent ions and especially zinc and/or manganese ions have been included for their ability to inhibit corrosion on metal and/or glass. Zinc sulphate is a preferred compound for this purpose.

Any conventional amount of multivalent ions/multivalent ions source may be included in the compositions of the invention. However, it is preferred that the multivalent ions are present in an amount of from 0.01% wt, preferably of from 0.05% wt, preferably of from 0.1% wt. It is preferred that the multivalent ions are present in an amount of up to 5% wt, preferably up to 3% wt, preferably up to 2.5% wt.

Performance Polymers

Polymers intended to improve the cleaning performance of the detergent compositions may also be included therein. For example sulphonated polymers may be used. Preferred examples include copolymers of CH₂═CR¹—CR²R³—O—C₄H₃,R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof.

When a sulfonated polymer is present, it is preferably present in the composition in an amount of at least 0.1% wt, preferably at least 0.5% wt, more preferably at least 1% wt, and most preferably at least 2% wt. A sulfonated polymer, when present, is preferably present in the composition in an amount of up to 20% wt, preferably up to 10% wt, more preferably up to 5% wt.

Enzymes

The detergent composition of the invention may comprise one or more enzymes. It is preferred that the enzyme is selected from protease, lipase, amylase, cellulase and peroxidase enzymes.

Desirably enzyme(s) is/are present in the composition in an amount of from 0.01% wt, especially of from 0.1% wt, most preferably of from 0.2% wt. Desirably enzyme(s) is/are present in the composition in an amount of up to 10% wt, preferably up to 7% wt, most preferably up to 5% wt.

Bleaching Compounds

Any type of bleaching compound conventionally used in detergent compositions may be used according to the present invention. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

When a bleaching compound is present in the pre-cleaning composition it is suitably present in an amount up to 40% wt, preferably up to 20% wt, preferably up to 10% wt, preferably up to 5% wt.

A bleaching compound may be protected from another component which it may degrade, and/or which may cause its own degradation. For examples a bleaching compound and an enzyme maybe be protected from each other, by physical separation. Physical separation may, for example, take the form of a coating around one or both such component, or by providing such components in separate compartments within the canister.

Other Components

The detergent compositions of the invention may also comprise minor, conventional amounts of thickeners, wetting agents, perfumes, preservatives and/or colourants. Such ingredients are typically present in amounts of up to 2% wt.

The pre-cleaning composition may suitably comprise water. Suitably the water content is not more than 80% wt, preferably not more than 65% wt, preferably not more than 45% wt, preferably not more than 30% wt, and in some preferred embodiments not more than 20% wt.

The composition when in the canister preferably contains, mixed within the composition, a propellant. Suitably such a propellant is a gaseous hydrocarbon, most preferably butane. Such a propellant preferably constitutes at least 0.2% wt of the composition, preferably at least 0.5% wt, and most preferably at least 0.8% wt. Preferably such a propellant constitutes not more than 8% wt of the composition, preferably not more than 4% wt, more preferably not more than 2% wt.

It is preferred that the pre-cleaning composition contains up to 80% wt water and up to 8% wt propellant, and has one or more of the following components in the amount stated:
5-70% wt builder(s),
0.1-10% wt surfactant(s),
0.01-5% wt, anti-corrosion agent(s),
0.1-20% wt performance polymer(s), preferably sulphonated polymer(s),
0.1-5% wt enzyme(s).

Suitably the aerosol canister will contain a bag on valve system, and the composition, containing the aforementioned propellant, is provided within the bag, and open to the valve, and thus able to exit the canister when the valve is open. This process is aided by a second propellant, inside the canister but outside the bag. Thus the canister preferably contain a bag which contains the pre-cleaning composition and includes a propellant, and a second propellant around the bag. Typically this second propellant is compressed air or nitrogen. Two (or more) bags may be provided inside the canister when components are best kept apart, as described above.

All of the numerical definitions given above for amounts of a component represent the total amount of such components, when more than one is present e.g. when there are two types of enzyme.

% wt values given herein mean percentage by weight of the specified component, as a percentage of the total weight of the composition.

Preferably the pre-cleaning composition does not contain any particulate components.

Preferably the pre-cleaning composition does not contain any sulphonate or alkyl sulphosuccinate surfactants.

Most preferably the pre-cleaning composition contains a non-ionic surfactant but no anionic surfactant or other surfactant type.

The dishwashing composition used in the dishwashing step may be the same composition as the pre-cleaning composition. Alternatively it may use a second composition. A second composition could be of the same general type as the pre-cleaning composition, although different in its formulation, or it could be substantially different.

A second dishwashing composition could be a dishwashing powder, liquid, gel or pouch, or tablet product, as used conventionally. A tablet or gel or pouch may be wrapped in a water-soluble polymer, for example a suitable polyvinyl alcohol grade.

Good results have been achieved by use of the present invention. Kitchenware articles are cleaned effectively, even when they have adherent food soils on them, even baked-on food soils. Frequently only one part of an article may be heavily soiled and the present method is efficient in allowing the first composition to be applied locally, onto that soil. The foam is believed to provide intimate contact with the soil. The foam provides a visual check for the user, that the soil has been fully covered.

In accordance with a second aspect of the present invention there is provided the use, prior to machine dishwashing, of a pre-treatment foam composition applied locally to soils on a kitchenware article. A “foam composition” here means a foam, foaming or foamable composition.

Preferred features of the use of the second aspect are as given above for the method of the first aspect.

The invention will now be further described, by way of example, with reference to the following embodiment.

The following three gel formulations were prepared.

| Relative % | Relative % | Relative % | Function |
|---|---|---|---|
| 0.200 | 0.200 | 0.200 | Dye |
| 0.300 | 0.300 | 0.300 | Preservative |
| 1.600 | 1.600 | 1.600 | Additives |
| 0.100 | 0.100 | 0.100 | Corrosion Inhibitor |
| 0.600 | 0.600 | 0.600 | Thickener |
| 2.500 | 2.500 | 2.500 | Surfactant |
| 2.700 | 2.700 | 2.700 | Sulfonated Polymer |
| 30.000 | 30.000 | 30.000 | Complexing agent (GLDA) |
| 0.500 | 0.500 | 0.500 | Amylase Enzyme |
| 4.000 | 4.000 | 4.000 | Protease Enzyme |
| 0.300 | 0.300 | 0.300 | Fragrance |
| 1.961 | 1.478 | 0.990 | Propellant (Butane-40) |
| 55.239 | 55.722 | 56.210 | Solvent (water) |

GLDA = Glutamic acid, N,N-diacetic acid, tetrasodium salt

These pre-cleaning compositions were loaded into respective aerosol canisters of the bag-in-canister type. An inert gas under pressure occupied the space between the bag, containing the respective composition, and the canister walls.

The compositions were tested in a range of tests. The tests involved different food soils, including baked-on soils, on a range of cookware, including metal baking trays, stainless steel cooking pans, clayware baking dishes and enamelled cast-iron oven dishes. The compositions were emitted from the containers as a gel which quickly (within 1 minute) formed a mousse-like but low-level foam (foam coefficient of approximately 40%). Application was sometimes over the whole cooking surface of the respective article, and sometimes only over the soil. After 1 hour, during which time the foam was maintained, the various cookware was washed in a domestic dishwashing machine, on a 50° C. cycle, no pre-wash, some using a proprietary cleaning block sold under the Registered Trade Mark FINISH, and some using the same cleaning composition, fully-filled into the loading chamber of the dishwasher. Comparison dishes were included which did not have the pre-treatment. The dishes which had the pre-treatment all came out of the dishwasher perfectly clean and showed superior performance.

1. A method of cleaning an article comprising:
pretreating with a pre-cleaning composition from a pressurized source the article; and
washing the article in a dishwashing machine using a dishwashing composition;
wherein the pre-cleaning composition provides a cleaning foam on a surface of the article.

2. The method as claimed in claim 1, wherein in the pre-treatment step the pre-cleaning composition is applied to substantially the entire cooking surface of the article.

3. The method as claimed in claim 1, wherein in the pre-treatment step the pre-cleaning composition is applied locally onto a part of the cooking surface of the article.

4. The method as claimed in claim 1, wherein the pre-cleaning composition is in the form of a liquid or gel when it is applied to the article, and it subsequently foams.

5. The method as claimed in claim 1, wherein the pre-cleaning composition is applied to the surface of the article as a foam.

6. The method as claimed in claim 5, wherein the pre-cleaning composition is already a foam when it reaches the article, but subsequently undergoes a second stage of foaming, when on a surface of the article.

7. The method as claimed in claim 5, wherein a pre-cleaning composition which foams, or foams further, on the article has finished its foaming within 20 minutes of being applied to the article.

8. The method as claimed in claim 1, the pre-cleaning composition having an initial condition when initially applied to the article, and a foamed condition, wherein the expansion coefficient of the foam on the article in the foamed condition to the pre-cleaning composition when in the initial condition is up to 1000%.

9. (canceled)

10. The method as claimed in claim 1, wherein the pre-treatment step includes a dwell time, after the pre-cleaning composition is applied to the article, and lasting until the commencement of the washing step, the dwell time preferably being at least 5 minutes.

11. The method as claimed in claim 1, wherein the pre-cleaning composition has a pH in the range of from 7 to 13.

12. The method as claimed in claim 1, wherein the pre-cleaning composition comprises:
up to 80% wt water;
up to 8% wt propellant; and
one or more of the following components:
5-70% wt builder;
0.1-10% wt surfactant;
0.01-5% wt anti-corrosion agent;
0.1-20% wt performance polymer; and
0.1-5% wt enzyme.

13. The method as claimed in claim 1, wherein the pressurized source comprises a pressurized aerosol canister, and wherein the canister contains a bag which contains the pre-cleaning composition and includes a propellant, and a second propellant around the bag.

14. The method as claimed in claim 1, wherein the dishwashing composition used in the dishwashing step is the same composition as the pre-cleaning composition.

15. (canceled)

16. The method as claimed in claim 5, wherein a pre-cleaning composition which foams, or foams further, on the article has finished its foaming within 10 minutes of being applied to the article.

17. The method as claimed in claim 5, wherein a pre-cleaning composition which foams, or foams further, on the article has finished its foaming within 5 minutes of being applied to the article.

18. The method as claimed in claim 5, wherein a pre-cleaning composition which foams, or foams further, on the article has finished its foaming within 2 minutes of being applied to the article.

19. The method as claimed in claim 5, wherein a pre-cleaning composition which foams, or foams further, on the article has finished its foaming within 1 minutes of being applied to the article.

20. The method as claimed in claim 1, the pre-cleaning composition having an initial condition when initially applied to the article, and a foamed condition, wherein the expansion coefficient of the foam on the article in the foamed condition to the pre-cleaning composition when in the initial condition is up to 500%.

21. The method as claimed in claim 1, the pre-cleaning composition having an initial condition when initially applied to the article, and a foamed condition, wherein the expansion coefficient of the foam on the article in the foamed condition to the pre-cleaning composition when in the initial condition is up to 100%.

22. The method as claimed in claim 1, the pre-cleaning composition having an initial condition when initially applied to the article, and a foamed condition, wherein the expansion coefficient of the foam on the article in the foamed condition to the pre-cleaning composition when in the initial condition is up to 50%.

23. The method as claimed in claim 1, the pre-cleaning composition having an initial condition when initially applied to the article, and a foamed condition, wherein the expansion coefficient of the foam on the article in the foamed condition to the pre-cleaning composition when in the initial condition is up to 30%.

24. The method as claimed in claim 1, the pre-cleaning composition having an initial condition when initially applied to the article, and a foamed condition, wherein the expansion coefficient of the foam on the article in the foamed condition to the pre-cleaning composition when in the initial condition is at least 5%.

25. The method as claimed in claim 1, wherein the pre-treatment step includes a dwell time, after the pre-cleaning composition is applied to the article, and lasting until the commencement of the washing step, the dwell time being at least 15 minutes.

26. The method as claimed in claim 1, wherein the pre-treatment step includes a dwell time, after the pre-cleaning composition is applied to the article, and lasting until the commencement of the washing step, the dwell time being at least 30 minutes.

27. The method as claimed in claim 1, wherein the pre-treatment step includes a dwell time, after the pre-cleaning composition is applied to the article, and lasting until the commencement of the washing step, the dwell time being at least 1 hour.

28. The method as claimed in claim 1, wherein the pre-treatment step includes a dwell time, after the pre-cleaning composition is applied to the article, and lasting until the commencement of the washing step, the dwell time being at least 8 hours.

29. The method as claimed in claim 1, wherein the pre-treatment step includes a dwell time, after the pre-cleaning composition is applied to the article, and lasting until the commencement of the washing step, the dwell time being at least 12 hours.

30. The method as claimed in claim 1, wherein the pre-treatment step includes a dwell time, after the pre-cleaning composition is applied to the article, and lasting until the commencement of the washing step, the dwell time being at least 24 hours.
